(19) United States
(12) Patent Application Publication
(10) Pub. No.: US 2002/0194107 A1
(43) Pub. Date: Dec. 19, 2002

(54) System for trading financial assets using volume weighted average price

(76) Inventors: Bin Li, Westport, CT (US); Michael Wu, Jersey City, NJ (US); Nan Lu, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 09/875,419

(22) Filed: Jun. 6, 2001

(51) Int. Cl. G06F 17/60

(52) U.S. Cl. 705/37; 705/36

(57) ABSTRACT

The invention relates to a system and method for trading financial assets comprising a computer, software executing on the computer for receiving at least one request for buying a specified financial asset and an indication of a specified future time period for buying the specified financial asset, software executing on the computer for receiving at least one offer for selling a specified financial asset and an indication of a specified future time period for selling the specified financial asset, software executing on the computer for automatically matching the at least one request for buying with the at least one offer for selling, and software executing on the computer for automatically computing, after expiration of the specified time period, a volume weighted average price of all shares of the financial asset traded during the time period.

### FIELD OF THE INVENTION

The invention relates to a system for trading financial assets and, more particularly, a system for automatically calculating a volume weighted average price from a plurality of share prices of financial assets traded during a specified time period.

### BACKGROUND OF THE INVENTION

Trading stocks, bonds, securities, commodities, and other liquidities has generally been done through brokers or traders who buy/sell on behalf of investors. When an investor wishes to buy or sell a particular stock, he/she would tell his/her broker and the broker would execute the investor's wish. Typically, the broker or trader would charge a commission or fee to the investor in transacting the trade. These transaction costs may be in the form of a percentage or flat fee. Further, the transaction costs may be charged prior to investing the investor's money, or taken off the top, or may be charged in the form of an invoice to the investor. No matter the form, transaction costs are generally proportional to the amount of trades the investor wishes to make. Hence, the more shares the investor wishes to buy or sell, the higher the costs.

Besides larger transaction costs, a further disadvantage to investors buying or selling large amounts of financial assets is that the trading price at which the brokers trade the investor's assets is not certain to be the best price available. Furthermore, automated or online systems that facilitate trading also lack the ability to both minimize transaction costs for trading large amounts of stock and obtain the most advantageous price for investors. Due to system limitations or some of the desired shares of a particular stock being unavailable for purchase, an investor or trader may buy several thousand shares at one time above market price because he/she does not know if more shares will be available at a later time at a lower price.

Known systems often lack the capacity to trade large volumes of assets efficiently. For example, an investor wishing to buy 5,000 or more shares of stock, which typically constitute a large volume, may find that buying this amount often requires a lengthy period of time negotiating with other brokers until the desired volume is reached. In essence, a broker would spend much time conversing with multiple other brokers in an effort to ascertain the amount of shares and price of those shares they are willing to sell. This would continue until the 5,000 shares are purchased. Using known systems for trading large volumes often requires personnel to perform multiple transactions and this may prove to be unwieldly and monotonous.

Traditionally, a broker seeking to fulfill a large request may spend an entire day on the phone with other brokers seeking to sell shares of the financial asset. If the brokers selling shares are selling only a part of what the buying broker needs, the buying broker may continue calling other selling brokers until the request has been fulfilled. Because the buying broker has spent a great deal of time searching for sellers, he/she typically passes this expense onto the investor who made the request.

In addition to investors trading vast numbers of shares, investors seeking modest, or smaller, trades are also subjected to proportional transaction costs and unpredictable trading prices. Further, investors are subjected to short term fluctuations in trading prices between the time investors authorize assets to be purchased and when the purchase is actually completed. Although this time may appear to be brief, fluctuations in price may be substantial and unpredictable. The fluctuations become exacerbated as investors trade more frequently, such as with day trading. Hence, trading success depends, in part, on chance, or luck, as to whether or not the unpredictable short term fluctuations are beneficial or detrimental.

What is desired, therefore, is a system for trading financial assets with reduced transaction costs. What is also desired is a system for obtaining a desirable trading price when trading financial assets. What is further desired is a system that facilitates trading financial assets for all types of investors, big or small. What is yet further desired is a system that provides a trading price that eliminates chance and minimizes negative effects of short term fluctuations.

### SUMMARY OF THE INVENTION

Accordingly, it is an object of the invention to provide a system for trading financial assets that receives requests to purchase a specified financial asset at a specified future time period.

It is also an object of the invention to provide a system for trading financial assets that receives offers to sell a specified financial asset at a specified future time period.

It is another object of the invention to provide a system that matches the requests for purchasing shares with offers to sell shares.

It is another object of the invention to provide a system for trading financial assets that automatically calculates a volume weighted average price of all shares of the financial asset traded during the specified time period.

These and other objects of the invention are achieved by a system for trading financial assets comprising a computer, software executing on the computer for receiving at least one request for buying a specified financial asset and an indication of a specified future time period for buying the specified financial asset, software executing on the computer for receiving at least one offer for selling a specified financial asset and an indication of a specified future time period for selling the specified financial asset, software executing on the computer for automatically matching the at least one request for buying with the at least one offer for selling, and software executing on the computer for automatically computing, after expiration of the specified time period, a volume weighted average price of all shares of the financial asset traded during the time period and for specifying the automatically computed volume weighted average price for the matched at least one request and at least one offer.

The system may further comprise software executing on the computer for retrieving, after expiration of the specified time period, price information of all shares of the financial asset traded during the time period for computing the volume weighted average price.

The system may further comprise software for denying or delaying the request for buying a financial asset if the request is received after the commencement of the specified time period. Moreover, the system may further comprise software for providing a chance for a buyer to elect to cancel or delay his/her request for buying if the request is received after the specified time period has begun to elapse.

Similarly, the system may further comprise software for denying or delaying the offer for selling a financial asset if the offer is received after the commencement of the specified time period. Likewise, the system may further comprise software for providing a chance for a seller to elect to cancel or delay his/her offer for selling if the offer is received after the specified time period has begun to elapse.

The specified time period is a predetermined interval of time. It is known so that buyers and sellers are aware of the time constraints in which to submit their requests or offers. The time periods may be determined according to trading patterns, such as anticipated peaks or lulls in trading activity. The time periods may also be determined according to agency guidelines, such as the Securities Exchange Commission. The time periods may further be arbitrarily determined. The time period may further comprise any length of time, such as minutes, days, weeks, months, years, or combinations of the above.

The system may further comprise a database in communication with the computer for storing price information. Price information may also be stored and retrieved from the database on a real time basis.

The software executing on the computer for automatically matching the requests with the offers matches them in any known or novel manner for matching, such as first come first served, last in is first out, or according to the type or amount of shares being requested for purchase or offered for sale.

In another embodiment of the invention, the system for trading financial assets comprising a computer, software executing on the computer for receiving at least one request for buying a specified financial asset at a volume weighted average price for a specified future time period, software executing on the computer for receiving at least one offer for selling a specified financial asset at a volume weighted average price for a specified future time period, software executing on the computer for automatically matching the at least one request for buying with the at least one offer for selling, and software executing on the computer for automatically computing, after expiration of the specified time period, a volume weighted average price of all shares of the financial asset traded during the time period and for specifying the automatically computed volume weighted average price for the matched at least one request and at least one offer.

In another aspect of the invention, a method is provided in accordance with the invention. The method comprises the steps of receiving the request to buy a financial asset at a specified future time, receiving the offer to sell the financial asset at a specified future time, automatically matching the request with the offer, and automatically computing a volume weighted average price of all shares of the financial asset traded during the specified future time period. The method may further comprise the step of retrieving price information of the financial asset from database 60.

The method further comprises the step of retrieving price information of all shares of the financial asset traded during the time period. The price information may be stored on a database in connection with the computer. The method may further include the step of updating and retrieving the price information on a real time basis.

The invention and its particular features and advantages will become more apparent from the following detailed description considered with reference to the accompanying drawings.

### BRIEF DESCRIPTION OF THE DRAWINGS

FIG. 1 depicts the system for trading financial assets in accordance with the invention.

FIG. 2 depicts the method for trading financial assets in accordance with the invention.

FIG. 3 more particularly depicts the time periods during which price information is retrieved for calculating the volume weighted average price.

FIG. 4 more particularly depicts the request to buy a financial asset being matched with offers to sell the financial asset

### DETAILED DESCRIPTION OF THE DRAWINGS

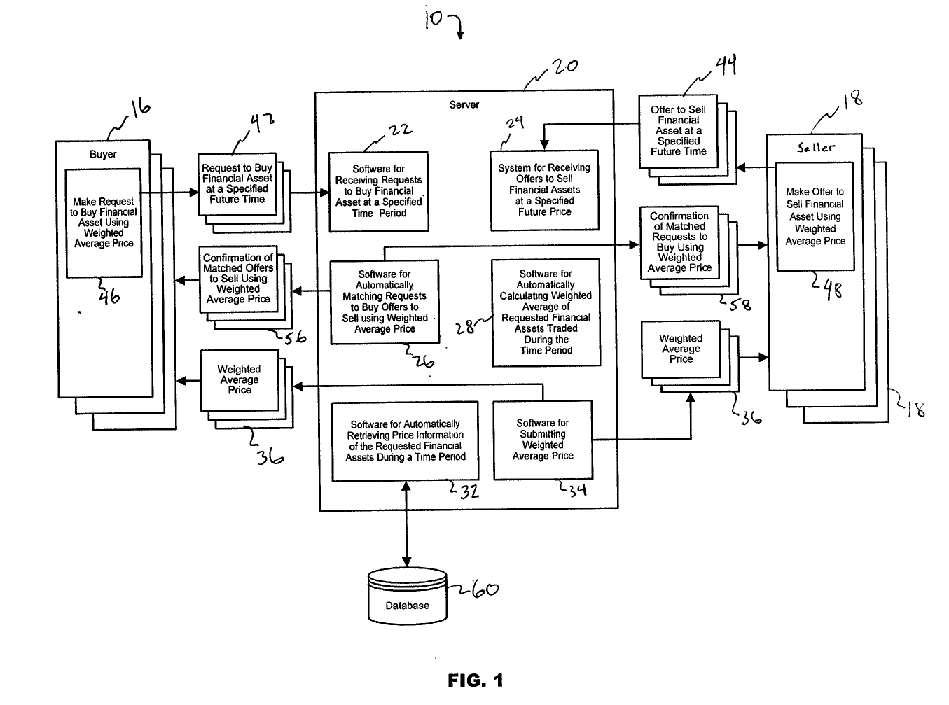

FIG. 1 depicts the system 10 for trading financial assets in accordance with the invention. System 10 operates to match requests for buying a financial asset with offers for selling the financial asset. The system further provides a calculated volume weighted average price of all shares of the financial asset traded during a specified time period, whereby the volume weighted average price is to be used as the trading price between the matched requests and offers.

Once a request to buy shares of a specified financial asset at a specified future time is given, system 10 matches the request with any offers to sell shares of the same specified financial asset. The system continues matching requests 42 with offers 44 to sell until all shares requested to be bought have been matched. Likewise, the system continues matching offers 44 with requests 42 until all offers have been matched. For example, if a buyer makes a request to buy 10,000 shares of Cisco at a specified future time, system 10 continually matches this request with offers from sellers who are wishing to sell Cisco shares. A first seller may wish to sell only 1,000 shares, a second seller may wish to sell 6,000 shares, and a third seller may wish to sell 5,000 shares. System 10 matches these three offers to sell Cisco shares with the request to buy them. In addition, after the time period has expired, system 10 automatically calculates the volume weighted average price (“VWAP”) of all Cisco shares traded during the specified time period and submits it to the buyer and three sellers for use as the trading price to complete their transactions.

In the example above, should the first seller have 20,000 shares of Cisco to sell, system 10 need not continue matching with subsequent sellers because the request has been fulfilled with the first seller. Similarly, if there are insufficient offers to sell Cisco shares, then the request will be partially fulfilled and system 10 will match the request with as many offers to sell as available prior to the commencement of the specified future time period. Because request 42 can only be partially fulfilled, system 10 permits the buyer to either cancel his/her request or continue with the trade and receive a VWAP for his/her request that will only be partially fulfilled.

In other embodiments, where a request is not fulfilled completely, system 10 will not partially match the request and, hence, no matching will occur. In certain other embodiments, where there are multiple requests for buying the same financial asset or multiple offers to sell the same financial asset during the same future time period, a first come first served approach will be used to fulfill the requests/offers.

It should be noted that all requests 42 to buy and offers 44 to sell should be received prior to commencement of the specified future time period in order for system 10 to match requests 42 with offers 44. Furthermore, requests 42 and offers 44 should be received prior to commencement of the specified future time period in order to use the VWAP for that time period. This prevents a buyer or seller to unfairly view the performance of the financial asset at the beginning of the time period and make corrective action by subsequently electing to trade at the VWAP by submitting a request or offer prior to the expiration of the time period.

In other words, buyers and sellers wishing to trade at a future time using a VWAP need to commit to such a trade prior to the commencement of the time period. The VWAP is a price that is typically agreeable to both buyers and sellers because it generally is a price reflective of reduced transaction costs, which would otherwise be passed along to the buyers and sellers in the form of a buying price to the buyer that is higher than the VWAP or a selling price to the seller that is lower than the VWAP, or in the form of a higher service fee taken off the top from any sale or purchase.

If request 42 or offer 44 is received after a time period has commenced, system 10 will notify the buyer or seller that matching will not occur unless the buyer and/or seller elect to trade at a later time period that has not yet commenced. At this point, the buyer and/or seller may opt to cancel request 42 and/or offer 44.

System 10 comprises computer 20 in communication with buyer's terminal 16 and seller's terminal 18, both of which may also be computers. Buyer's terminal 16 and seller's terminal 18 communicate with computer 20 for the purpose of transmitting trade information related to financial assets. The communication may be over an Internet connection or any connection for transmitting financial asset trading information.

System 10 further comprises software 22 executing on computer 20 for receiving a request to buy financial assets at a specified time period, software 24 executing on computer 20 for receiving an offer to sell financial assets at a specified time period, software 26 executing on computer 20 for matching the requests to buy with the offers to sell, and software 28 executing on computer 20 for automatically calculating a volume weighted average price of all shares of the financial assets traded during the specified time period.

Once request 42 to buy a specified amount of financial asset at a future time is made 46 by a buyer, software 22 executing on computer 20 receives request 42 and system 10 begins matching request 42 with offer 44, which are offers to sell shares of the requested financial asset at a future time made 48 by a seller. Software 28 matches the requests to buy with the offers to sell and provides the matched results to the parties in the form of a confirmation 56 of matched offers to sell and confirmation 58 of matched requests to buy.

Once system 10 has received all requests 42 and offers 44 and has performed all matching, software 28 executing on computer 20 automatically calculates, at the expiration of the specified time period, a volume weighted average price of all shares of the financial asset traded during the time period according to the following formula:

$$VWAP = \frac{( \# of shares traded ) ( trading price of each share )}{total \# of shares traded}$$

For example, in the time period from 3 pm to 4 pm, 3 trades of stock XYZ took place: 100 shares at $20/share, 300 shares at $22/share, and 500 shares at $21/share. The VWAP for this time period is then VWAP=(100*20+300*22+500*21)/(100+300+500)=$21.22

Information of all shares of the financial asset traded during the specified time period is stored on database 60, which stores trading activity of all assets for all financial markets worldwide. Activity on Wall Street in the United States, benchmark indexes, foreign markets, and other related financial information are some examples of the data related to trading activity stored on database 60. In certain embodiments, price information is stored on database 60 on a real time basis.

In certain other embodiments, system 10 may further include software 32 executing on computer 20 for automatically retrieving price information of the requested financial asset. The retrieved price information is used by system 10 for calculating the VWAP. In certain other embodiments, software 32 retrieves price information on a real time basis.

Subsequent to calculating VWAP 36, software 34 for submitting the VWAP submits the VWAP to buyer and seller terminals, 16 and 18. In certain embodiments, software 34 submits VWAP automatically without user intervention.

The invention is particularly beneficial for institutional investors seeking to purchase a large amount of shares of a financial asset or assets. System 10 obtains a VWAP for purchasing the volume of shares while minimizing transaction costs. The invention further facilitates negotiations between buyers and sellers because the VWAP is typically agreeable to both parties.

The invention, however, need not apply solely to institutional investors. The investor may be an individual seeking at least one share of a financial asset. In the case of the investor requesting a small amount of shares, the invention insulates the investor from the possibility of buying at a high price. Hence, the VWAP protects the investor from undesired fluctuations in market price and gives an investor freedom to purchase an asset at anytime during the specified time period as opposed to trying to pin point the best moment to buy and avoid a jump in market price.

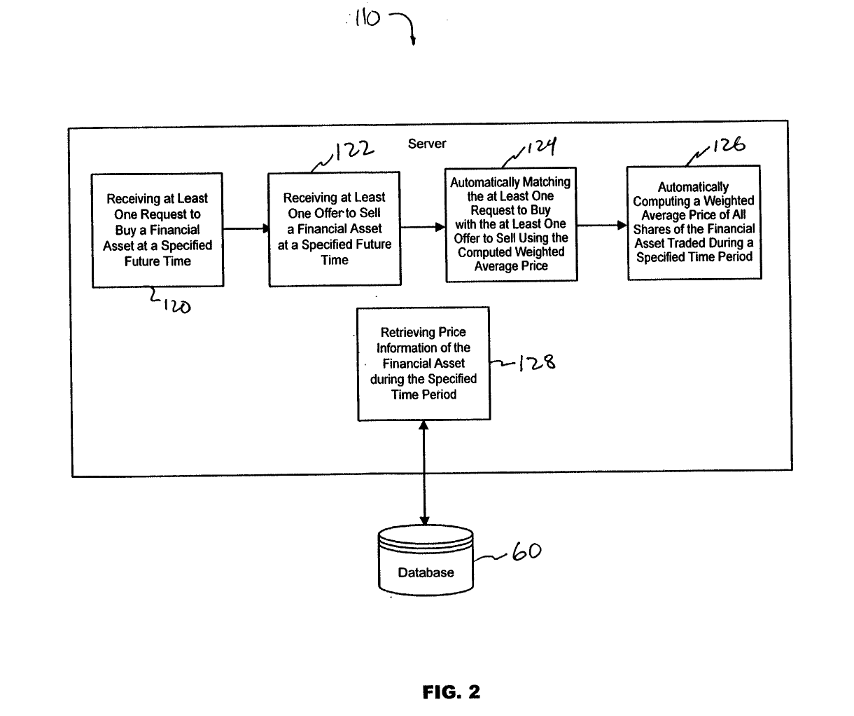

FIG. 2 depicts a method for trading financial assets in accordance with the invention. Method 110 comprises the steps of receiving 120 at least one request to buy a financial asset at a specified future time, receiving 122 at least one offer to sell the financial asset at a specified future time, automatically matching 124 the at least one request with the at least one offer, and automatically computing 126 a VWAP of all shares of the financial asset traded during the specified future time period. Method 110 may further comprise the step of retrieving 128 price information of the financial asset from database 60.

Receiving 120 at least one request to buy a financial asset includes requests from all investors, including individual investors seeking to insulate themselves from spikes in market price and institutional investors seeking large volumes of varying types of financial assets.

Receiving 122 at least one offer to sell the financial asset includes all offers to sell the financial asset received prior to commencement of the specified future time period.

After all offers to sell and requests to buy are received, method 110 matches the requests with the offers in order to fulfill all offers and all requests. For example, if there are 5 requests to buy a total of 15,000 shares of a financial asset and 8 offers to sell a total of 15,000 shares of the financial asset, method 110 matches these 5 requests with the 8 offers. However, the total number of shares to be bought typically does not equal in total number of shares to be sold. In this case, matching 124 includes partially fulfilling a request if there are insufficient offers to sell by matching the request with as many offers to sell as available. Conversely, method 110 partially fulfills an offer to sell if there are insufficient requests to buy. Method 110 performs matching on a first come first served basis with respect to the order of both requests 42 and offers 44. Further, method 110 may automatically match 124 requests and offers using any other arrangement, such as last in first out.

Matching 124 between requests and offers is performed provided they are received prior to commencement of the time period. If a request or offer is received during or after the time period, method 110 will not permit the buyers or offerors to trade using the VWAP unless the buyers or sellers elect to use the VWAP for a later, or future, time period that has not commenced at the time the request or offer is submitted.

After expiration of the specified future time period, method 110 automatically computes 126 a VWAP of all shares of the financial asset traded during the time period. The price information used for computing the VWAP includes all trading prices of the financial asset during the time period. The calculated VWAP is then submitted to the buyer and seller for use as the trading price for the financial asset.

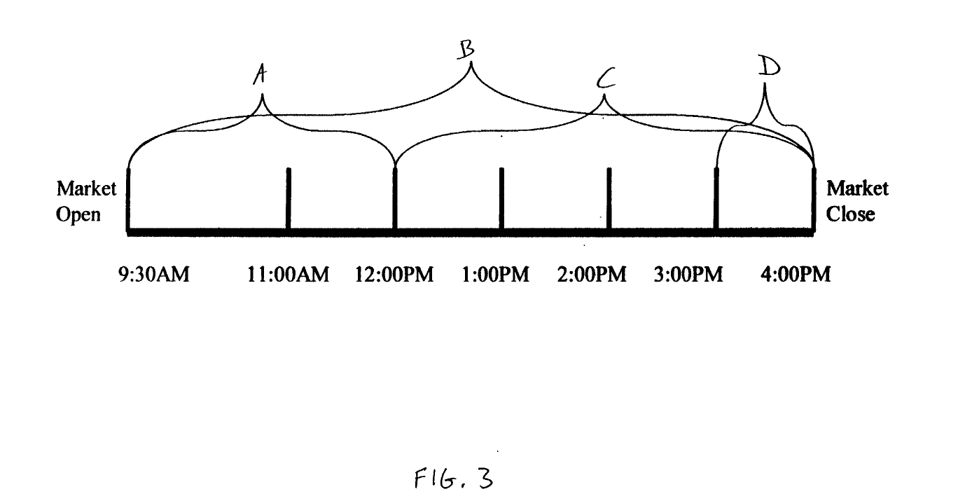

FIG. 3 depicts the time periods in accordance with the invention. Although the time period shown is depicted in terms of hours, time periods may also be in terms of minutes, days (shown as time period B), weeks, months, or years. In certain embodiments, they are predetermined according to trading patterns, such as times during the day, week, month, or year when trading is generally heavy, shown as time period D, or light, shown as time period A. In other embodiments, they are predetermined according to agency guidelines, such as the SEC. In still other embodiments, they are predetermined according to the type of financial asset or market, such as technology sectors, foreign, or bond markets. In certain other embodiments, time periods are arbitrarily determined, shown as time period C.

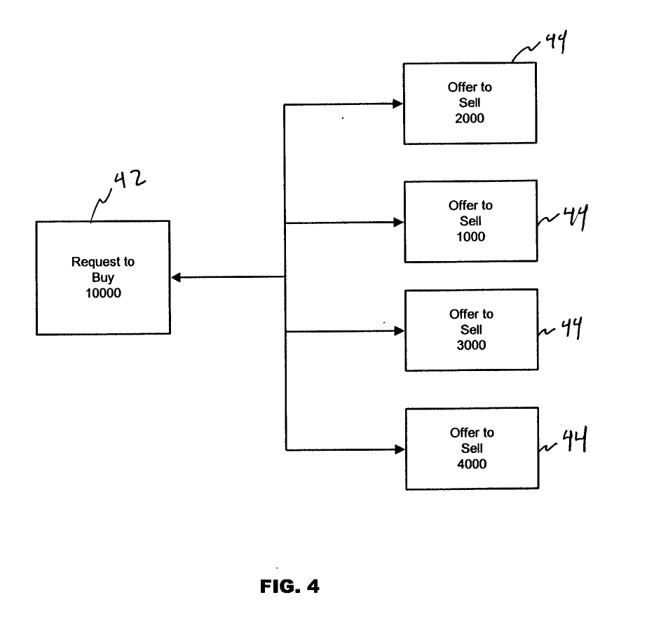

FIG. 4 more particularly depicts request 42 to buy a financial asset being matched with offers 44 to sell the financial asset. For exemplary purposes only, request 42 is for purchasing 10,000 shares of a financial asset. System 10 matches request 42 with offers 44 for selling shares of the same financial asset in order to fulfill the request. Offers 44 include a plurality of offers from a plurality of offerors.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A system for trading financial assets, comprising:
a computer;
software executing on said computer for receiving at least one request for buying a specified financial asset and an indication of a specified future time period for buying the specified financial asset;
software executing on said computer for receiving at least one offer for selling a specified financial asset and an indication of a specified future time period for selling the specified financial asset;
software executing on said computer for automatically matching the at least one request for buying with the at least one offer for selling; and
software executing on said computer for automatically computing, after expiration of the specified time period, a volume weighted average price of all shares of the financial asset traded during the time period and for specifying the automatically computed volume weighted average price for the matched at least one request and at least one offer.

2. The system according to claim 1, further comprising software executing on said computer for retrieving, after expiration of the specified time period, price information of all shares of the financial asset traded during the time period.

3. The system according to claim 1, further comprising software executing on said computer for denying the request for buying if the request is received after the specified time period has begun to elapse.

4. The system according to claim 1, further comprising software executing on said computer for delaying the request for buying if the request is received after the specified time period has begun to elapse.

5. The system according to claim 1, further comprising software executing on said computer for providing a chance for a buyer to either cancel or delay the request for buying if the request is received after the specified time period has begun to elapse.

6. The system according to claim 1, further comprising software executing on said computer for providing an opportunity for a seller to either cancel or delay the offer for selling if the offer is received after the specified time period has begun to elapse.

7. The system according to claim 1, further comprising software executing on said computer for delaying the offer for selling if the offer is received after the specified time period has begun to elapse.

8. The system according to claim 1, further comprising software executing on said computer for permitting a user to elect to cancel the offer for selling if the offer is received after the specified time period has begun to elapse.

9. The system according to claim 1, wherein the specified time period is predetermined.

10. The system according to claim 1, wherein the specified time period is selected from the group consisting of minutes, days, weeks, months, years, and combinations thereof.

11. The system according to claim 1, further comprising a database in communication with said computer for storing said price information.

12. The system according to claim 11, further comprising software executing on said computer for storing and retrieving price information from said database.

13. The system according to claim 1, further comprising software executing on said computer for automatically updating said price information in real time.

14. The system according to claim 1, further comprising software executing on said computer for matching at least one request with at least one offer in an order in which requests for buying are received.

15. The system according to claim 1, wherein said at least one request is partially matched.

16. The system according to claim 1, further comprising software executing on said computer for matching at least one request with at least one offer in an order in which offers for selling are received.

17. The system according to claim 1, wherein said at least one offer is partially matched.

18. A system for trading financial assets, comprising:
a computer;
software executing on said computer for receiving at least one request for buying a specified financial asset at a volume weighted average price for a specified future time period;
software executing on said computer for receiving at least one offer for selling a specified financial asset at a volume weighted average price of a specified future time period;
software executing on said computer for automatically matching the at least one request for buying with the at least one offer for selling; and
software executing on said computer for automatically computing, after expiration of the specified time period, a volume weighted average price of all shares of the financial asset traded during the time period and for specifying the automatically computed volume weighted average price for the matched at least one request and at least one offer.

19. The system according to claim 18, further comprising software executing on said computer for retrieving, after expiration of the specified time period, price information of all shares of the financial asset traded during the time period.

20. The system according to claim 18, further comprising software executing on said computer for matching at least one request with at least one offer in an order in which requests for buying are received.

21. The system according to claim 18, wherein said at least one request is partially matched.

22. The system according to claim 18, further comprising software executing on said computer for matching at least one request with at least one offer in an order in which offers for selling are received.

23. A method for trading large volumes of financial assets, comprising:
providing a computer;
receiving at least one request to buy a financial asset at a specified future time period;
receiving at least one offer to sell the financial asset at a specified future time period;
automatically matching said at least one request with said at least one offer; and
automatically computing, at the expiration of the specified future time period, a volume weighted average price of all shares of the financial asset traded during the time period.

24. The method according to claim 23, further comprising the step of retrieving price information of all shares of the financial asset traded during the time period.

25. The method according to claim 23, further comprising the step of retrieving price information of the financial asset from a database.

26. The method according to claim 23, further comprising the step of denying said at least one request for buying if said at least one request is received after the specified time period has begun to elapse.

27. The method according to claim 23, further comprising the step of permitting a user to elect to delay said at least one offer for selling if said at least one offer is received after the specified time period has begun to elapse.

28. The method according to claim 23, further comprising the step of updating said price information on a real time basis.

29. The method according to claim 23, further comprising the step of retrieving said price information on a real time basis.
